(19) United States
(12) Patent Application Publication
(10) Pub. No.: US 2026/0360250 A1
(43) Pub. Date: Nov. 12, 2026

(54) MONITORING SYSTEM, MONITORING METHOD, AND COMPUTER READABLE MEDIUM

(71) Applicant: NEC Corporation, Minato-ku, Tokyo (JP)

(72) Inventors: Murtuza PETLADWALA, Tokyo (JP); Yoshiyuki YAJIMA, Tokyo (JP); Takahiro KUMURA, Tokyo (JP)

(73) Assignee: NEC Corporation, Minato-ku, Tokyo (JP)

(21) Appl. No.: 19/121,170

(22) PCT Filed: Nov. 25, 2022
(86) PCT No.: PCT/JP2022/043586

§ 371 Date: Apr. 15, 2025

(51) Int. Cl. G08G 1/01; G01H 9/00; G06N 3/02; G08G 1/04

(52) U.S. Cl. CPC G08G 1/0129; G01H 9/004; G06N 3/02; G08G 1/0116; G08G 1/0145; G08G 1/04

(57) ABSTRACT

A monitoring system (10) includes a signal acquisition unit (12) that acquires oscillation data at each of a plurality of sensing points in an optical fiber cable, the optical fiber cable being installed along a transportation infrastructure including a plurality of sections with structures different from each other; a raw dataset processing unit (14) that obtains time-distance oscillation data of the road based on the oscillation data; a passband processing unit (16) that obtains a filtering parameter for the time-distance oscillation data of each section of the road based on a structural or dimensional property of the section; a waterfall processing unit (18) that obtains waterfall data by removing noise from the time-distance oscillation data of each section of the road using the filtering parameter; and a trajectory detection unit (20) that identifies a trajectory of a moving object passing on the road from the waterfall data.

### TECHNICAL FIELD

The present disclosure relates to a monitoring system, a monitoring method, and a non-transitory computer readable medium.

### BACKGROUND ART

The distributed acoustics sensing technology acquires surrounding vibration signals (acoustic signals) around an optical fiber cable. In the typical DAS technology, a pulse light in the optical fiber cable is transmitted, where the optical fiber cable is installed along a road infrastructure. The distributed acoustics sensing device acquires the infrastructure vibration signal around the road by analyzing a Rayleigh backscattered light of the pulse light.

The vibration patterns generated from vehicle traffic are measured by the optical fiber cable laid along the road. The traffic monitoring applications observe these vibration patterns in a real-time to maintain the smooth flow of traffic by continuously observing the traffic properties like vehicle speed and vehicle traffic counting.

The trajectory features are estimated from the 3D waterfall dataset obtained from the post-processing of the measured vibration signals. This is a commonly used way to represent vibration signals along a sensing fibre cable.

The 3D waterfall dataset is extracted by post-processing the multi-point vibration signals in a combination of low and high frequency bands and filtering parameters. A combined filter is applied to filter out noise information at those frequency bands. The 3D waterfall dataset is processed to obtain trajectory features that are used for traffic monitoring applications and traffic properties calculations.

Patent Literature 1 (PTL 1) discloses applying spectral filtering to vibration signals. Patent Literature 2 (PTL 2) discloses specifying bridge sections from the waterfall dataset.

### CITATION LIST

### Patent Literature

PTL 1: Published Japanese Translation of PCT International Publication for Patent Application, No. 2019-529952
PTL 2: Japanese Unexamined Patent Application Publication No. 2021-121917

### SUMMARY OF INVENTION

### Technical Problem

The trajectory features obtained from 3D waterfall dataset are filtered out in the filtering process using a common set of filtering parameters applied to all sensing points that correspond to locations on the road. However, sensing locations are oscillated according to dynamic and structural frequency responses that depend on each structure and its vibration characteristics upon excited. Therefore, it is possible that the waterfall dataset becomes noisy.

An exemplary object of the invention is to provide a monitoring system, a monitoring method and a non-transitory computer readable medium capable of decreasing noise in a waterfall dataset.

### Solution to Problem

According to one aspect of the disclosure, there is provided a monitoring system that includes:
signal acquisition means for acquiring oscillation data at each of a plurality of sensing points in an optical fiber cable, the optical fiber cable being installed along a transportation infrastructure including a plurality of sections with structures different from each other;
raw dataset processing means for obtaining time-distance oscillation data of the transportation infrastructure based on the oscillation data;
passband processing means for obtaining a filtering parameter for the time-distance oscillation data of each section of the transportation infrastructure based on a structural property of the section;
waterfall processing means for obtaining waterfall data by removing noise from the time-distance oscillation data of each section of the transportation infrastructure using the filtering parameter; and
trajectory detection means for identifying a trajectory of a moving object passing on the transportation infrastructure from the waterfall data.

According to one aspect of the disclosure, there is provided a monitoring method that includes:
acquiring oscillation data at each of the plurality of sensing points in an optical fiber cable, the optical fiber cable being installed along a transportation infrastructure including a plurality of sections with structures different from each other;
obtaining time-distance oscillation data of the transportation infrastructure based on the oscillation data;
obtaining a filtering parameter for the time-distance oscillation data of each section of the transportation infrastructure based on a structural property of the section;
obtaining waterfall data by removing noise from the time-distance oscillation data of each section of the transportation infrastructure using the filtering parameter; and
identifying a trajectory of a moving object passing on the transportation infrastructure from the waterfall data.

According to one aspect of the disclosure, there is provided a non-transitory computer readable medium storing a program for causing a computer to execute:
acquiring oscillation data at each of the plurality of sensing points in an optical fiber cable, the optical fiber cable being installed along a transportation infrastructure including a plurality of sections with structures different from each other;
obtaining time-distance oscillation data of the transportation infrastructure based on the oscillation data;
obtaining a filtering parameter for the time-distance oscillation data of each section of the transportation infrastructure based on a structural property of the section;
obtaining waterfall data by removing noise from the time-distance oscillation data of each section of the transportation infrastructure using the filtering parameter; and
identifying a trajectory of a moving object passing on the transportation infrastructure from the waterfall data.

### Advantageous Effects of Invention

According to the present disclosure, it is possible to provide a monitoring system, a monitoring method and a non-transitory computer readable medium capable of decreasing noise in a waterfall dataset.

### BRIEF DESCRIPTION OF DRAWINGS

FIG. 1 is a drawing for explaining an example of a 3D waterfall dataset.

FIG. 2 is a drawing for explaining the related art.

FIG. 3 is a drawing for explaining the monitoring system in accordance with a first example embodiment of the present invention.

FIG. 4A is a drawing for explaining a second example embodiment of the present invention.

FIG. 4B is a drawing for explaining the second example embodiment of the present invention.

FIG. 4C is a drawing for explaining the second example embodiment of the present invention.

FIG. 5 is a block diagram illustrating configuration example of the monitoring system in accordance with the second example embodiment of the present invention.

FIG. 6 is a drawing for explaining the monitoring system in accordance with the second example embodiment of the present invention.

FIG. 7 is a drawing for explaining the monitoring system in accordance with the second example embodiment of the present invention.

FIG. 8 is a table for explaining the filtering parameters in accordance with the second example embodiment of the present invention.

FIG. 9 is a flowchart for explaining an operation of the monitoring system in accordance with the second example embodiment of the present invention.

### DESCRIPTION OF EMBODIMENTS

### Study Leading to Embodiments

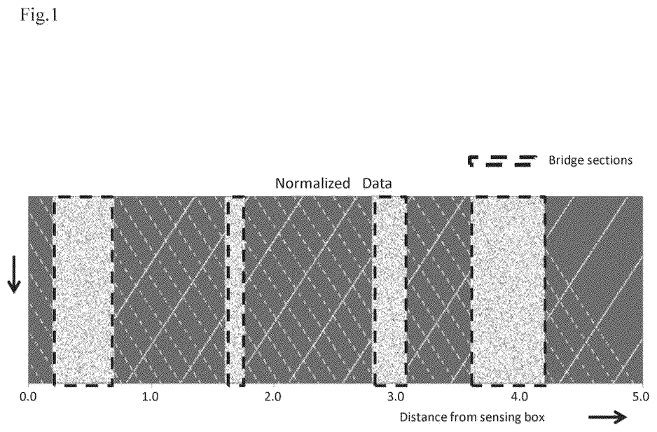

First, the contents of the study conducted by the inventor of the present application will be described. This is a commonly used way to represent vibration signals along a sensing fibre cable as shown in FIG. 1. The X-axis is distance from the sensing device (box) location, Y-axis is time and Z-axis corresponds to the amplitude of the vibration at that distance from the sensing device location. The amplitude is normalized. The waterfall dataset includes oscillation data of bridge sections surrounded by dashed boxes.

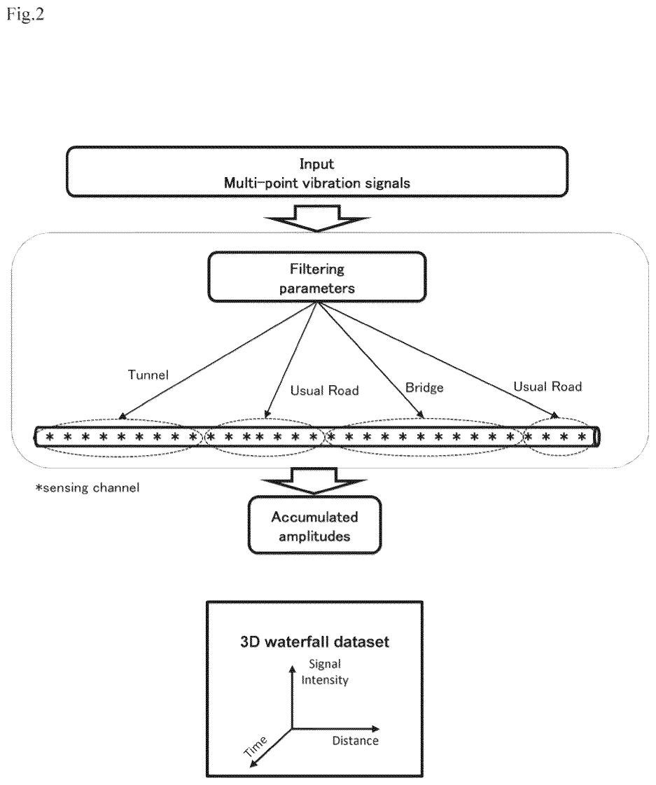

The trajectory features obtained from 3D waterfall dataset are filtered out in the filtering process using a common set of filtering parameters applied to all sensing points that correspond to locations on the road (e.g., a highway) as illustrated in FIG. 2. Multi-point vibration signals are input, the vibration signals are filtered out, and accumulated amplitudes are output. The amplitudes correspond to signal intensities. The set of filtering parameters is applied to 4 different sections (e.g., tunnels, usual roads, bridges) of the transportation infrastructure. However, sensing locations are oscillated according to dynamic and structural frequency responses that depend on each structure and its vibration characteristics upon excited. Therefore, it is possible that the waterfall dataset becomes noisy. The inventor of the present application arrived at the present disclosure according to the embodiments based on the above study.

Example embodiments according to the present disclosure will be described hereinafter with reference to the drawings. Note that the following description and the drawings are omitted and simplified as appropriate for clarifying the explanation. Further, the same elements are denoted by the same reference numerals (or symbols) throughout the drawings, and redundant descriptions thereof are omitted as required. Also, in this disclosure, unless otherwise specified, “at least one of A or B (A/B)” may mean any one of A or B, or both A and B. Similarly, when “at least one” is used for three or more elements, it can mean any one of these elements, or any plurality of elements (including all elements). Further, it should be noted that in the description of this disclosure, elements described using the singular forms such as “a”, “an”, “the” and “one” may be multiple elements unless explicitly stated.

### First Example Embodiment

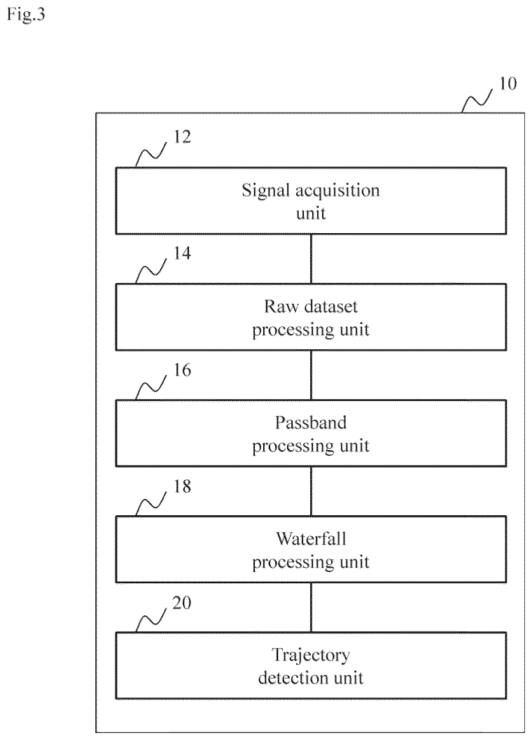

First, a monitoring system 10 according to a first example embodiment of the present disclosure is explained with reference to FIG. 3.

Referring to FIG. 3, the monitoring system 10 includes a signal acquisition unit 12, a raw dataset processing unit 14, a passband processing unit 16, and a waterfall processing unit 18, and a trajectory detection unit 20.

The signal acquisition unit 12 acquires oscillation data at each of a plurality of sensing points in an optical fiber cable. The optical fiber cable is installed along a transportation infrastructure including a plurality of sections with structures different from each other. The transportation infrastructure may be called a road. A plurality of sections may include tunnel sections, bridge sections and usual road sections. Usual road sections are supported by the ground.

The raw dataset processing unit 14 obtains time-distance oscillation data of the road and applies pre-processing steps like signal down sampling rate and unit conversion. For example, optical phase radian unit maybe converted to micro-strain units. The unit conversion may depend on the input settings of the measurement system.

The passband processing unit 16 obtains a filtering parameter for the time-distance oscillation data of each section of the transportation infrastructure based on a structural property of the section. The filtering parameter is also referred to as a structural passband parameter.

The waterfall processing unit 18 obtains waterfall data by removing noise from the time-distance oscillation data of each section of the transportation infrastructure using the filtering parameter.

The trajectory detection unit 20 identifies a trajectory of a moving object passing on the transportation infrastructure from the waterfall data. The moving object may be a vehicle, a train, a bicycle, or a pedestrian.

As the monitoring system 10 removes noise from the time-distance oscillation data based on the structural properties, it can decrease noise in the waterfall dataset.

Herein, the monitoring system 10 includes, as its components, a processor, a memory, and a storage device (none illustrated). The storage device stores a computer program that implements the processes of the monitoring method according to the present example embodiment. The processor loads the computer program from the storage device onto the memory and executes the computer program. Thus, the processor implements the functions of the acquiring unit 12, the raw dataset processing unit 14, the passband processing unit 16, the waterfall processing unit 18, and the trajectory detection unit 20.

Alternatively, the acquiring unit 12, the raw dataset processing unit 14, the passband processing unit 16, the waterfall processing unit 18, and the trajectory detection unit 20 may each be implemented by a dedicated piece of hardware. A part or the whole of the constituent elements of each device may be implemented by, for example, general-purpose or dedicated circuitry, a processor, or a combination thereof. Such constituent elements may be formed by a single chip or by a plurality of chips connected via a bus. A part or the whole of the constituent elements of each device may be implemented by a combination of the above-described circuitry or the like and a program. For the processor, a central processing unit (CPU), a graphics processing unit (GPU), a field-programmable gate array (FPGA), or the like can be used.

In a case where a part or the whole of the constituent elements of the monitoring system 10 is implemented by a plurality of information processing devices, circuitries, or the like, these information processing devices, circuitries, or the like may be disposed centrally or distributed. For example, these information processing devices, circuitries, or the like may be implemented in a mode in which they are connected to each other via a communication network, as in, for example, a client server system or a cloud computing system. The function of the monitoring system 10 may be provided in a Software as a Service (Saas) format.

### Second Example Embodiment

A second example embodiment of this disclosure will be described below referring to the accompanied drawings. This second example embodiment explains one of the specific examples of the first example embodiment, however, specific examples of the first example embodiment are not limited to this example embodiment.

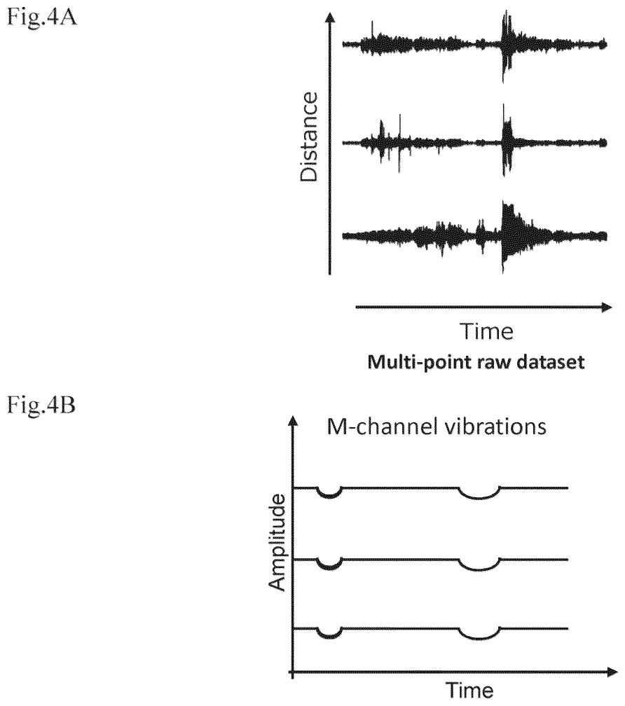

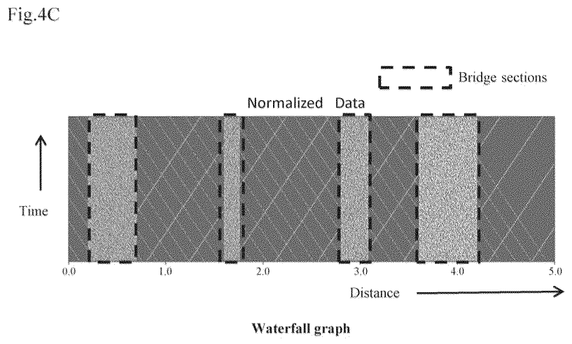

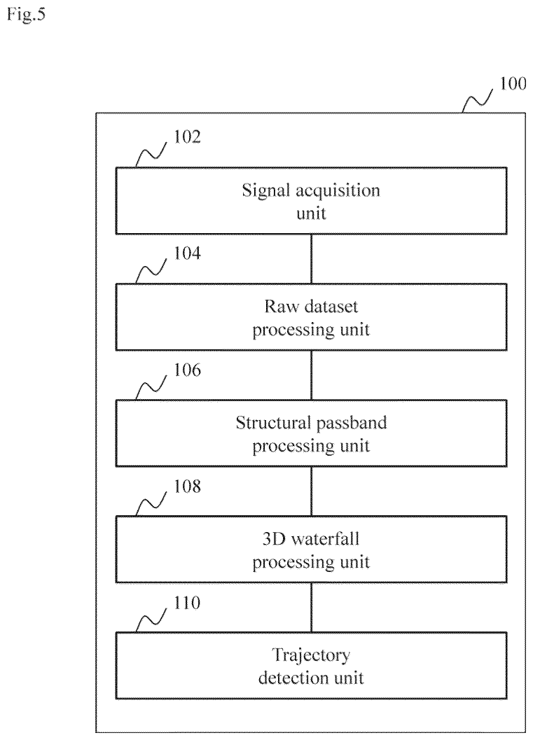

FIGS. 4A to 4C are drawings for explaining the summary of the second example embodiment.

FIG. 4A is an example illustration of raw vibration signal dataset (multi-point raw dataset) measured at every sequential point of the optical fiber cable attached to the road. The three vibration signals are illustrated as an example.

FIG. 4B illustrates the vibration signals obtained after applying structural passband filters over all the channels (sensing points) of the optical fiber cable, for illustration example three vibration signal channels are shown. The structural passband filter may be obtained from known structural properties of the given structure for example, a resonance frequency (natural frequency) or low frequencies that corresponds to displacement of the surface of the structure. The signals clearly show the presence of vehicles by the change in amplitude from the baseline amplitudes.

FIG. 4C illustrates the extracted 3D waterfall dataset. The first axis that is distance axis is the number of channels (sensing points) on the optical fiber cable. The second axis that is time axis is the time of the measurement. The third axis is the processed amplitude of the vibration signal after applying structural passband filter. For illustration purpose, the number of channels in FIG. 4C are greater than three channels, not illustrated in FIGS. 4A and 4B. The pixels in the 3D waterfall dataset are converted to white and black color to illustrate the presence and absence of vehicle respectively. The white color pixels of an individual vehicle are known as a trajectory of the vehicle in the time-distance plane. As compared to FIG. 1 vehicle trajectories that are continuity of white pixels are maintained even at the bridge sections.

Referring to FIG. 5, a monitoring apparatus 100 includes a signal acquisition unit 102, a raw dataset processing unit 104, a structural passband processing unit 106, a 3D waterfall processing unit 108 and a trajectory detection unit 110. The monitoring apparatus 100 is one specific example embodiment of the monitoring system 10. The monitoring apparatus 100 is also referred to as a Distributed Acoustics Sensing 3D waterfall extraction apparatus.

The monitoring apparatus 100 is connected to a distributed acoustic sensor (DAS). The DAS detects oscillation signals at the plurality of sensing points in the optical fiber cable, and transmits the oscillation signals to the monitoring apparatus 100.

The signal acquisition unit 102 is one specific example embodiment of the signal acquisition unit 12. The signal acquisition unit 102 acquires an oscillation signal (acoustics or vibration data) from the Interrogator, the DAS. The DAS is able to detect an oscillation signal of the road induced by vehicles, when the vehicle is passing on any traffic lane.

The raw dataset processing unit 104 is one specific example embodiment of the raw dataset processing unit 14. The raw dataset processing unit 104 obtains a vibration/acoustics signal for each of the sequential sensing points forming a time-distance chart (raw dataset in FIG. 4A). The raw dataset maybe used to obtain structural information like usual road section, bridge section and tunnel section from the pre-specified positions on the fiber cables. An example snap of 3D waterfall dataset generated from related art is illustrated in FIG. 1, where vehicles are going away and coming towards the sensing device and their vibration intensities are visible, which are proportional to the types of vehicles passing on the road. The dashed box represents the bridge sections present on the road, where the vibration intensities are unclear due to high vibrations of bridge sections.

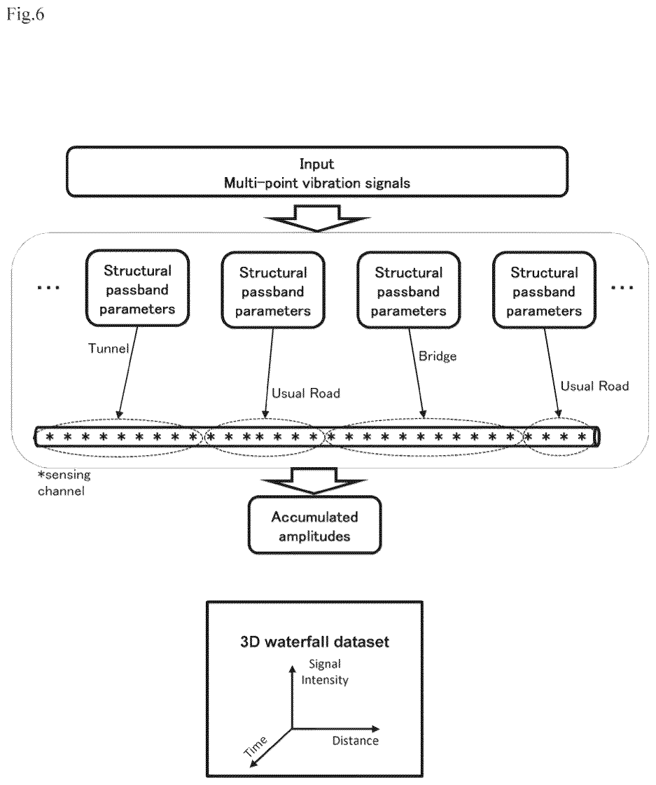

The structural passband processing unit 106 is one specific example embodiment of the raw dataset processing unit 16. The structural passband processing unit 106 obtains the structural passband parameters (filtering parameters) for each of the sections on the road as shown in FIG. 6. The raw dataset is used as input for obtaining the structural passband parameters.

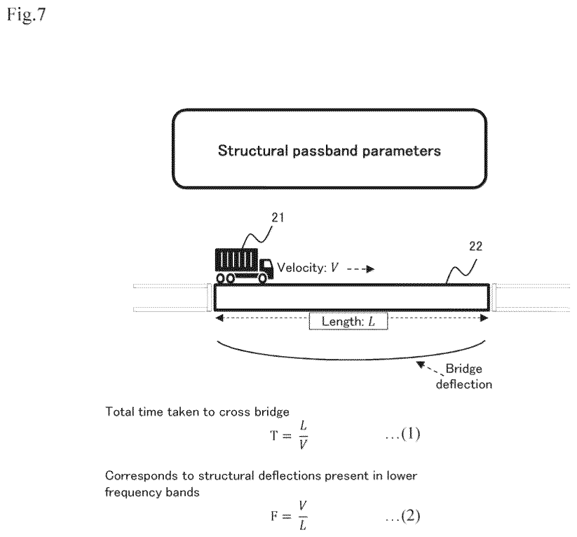

FIG. 7 illustrates the background of structural passband parameter selection. A vehicle (e. g., a truck) 21 with a velocity V is passing over the bridge section 22 of length L. As the vehicle 21 passes through the bridge section 22, bridge structures tend to displace from rest state, known as bridge deflection. Equation (1) represents the total time taken to cross the bridge section 22, where T is time taken in second, L is length of bridge in meter and V is vehicle speed in meter/second. To obtain the bridge deflection information from the measured raw dataset vibration signal, the signal's low frequency bands include this information. Equation (2) is the inverse of equation (1) from time T in second to frequency F in Hertz. The frequency from zero Hertz to the cut-off frequency F consists of all deflection information.

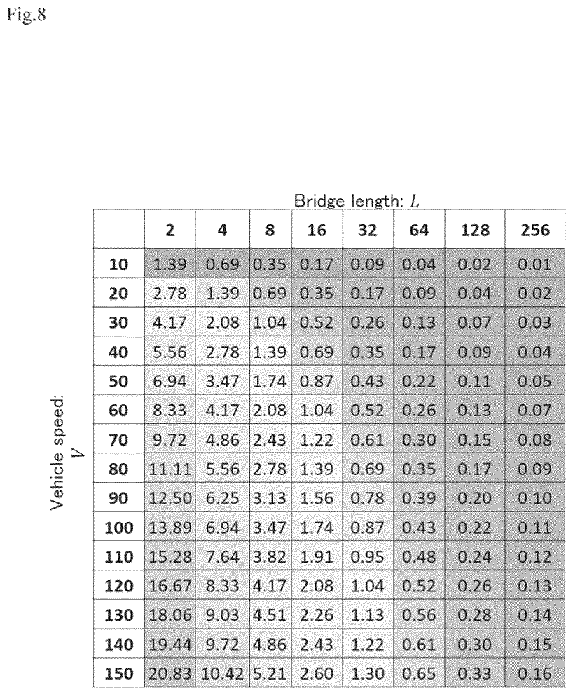

FIG. 8 is the table for cut-off frequency in Hertz obtained from equation (2) by assuming the possible vehicle speed V in kilometer per hour and bridge length L in meters.

Referring to FIG. 5, the 3D waterfall processing unit 108 is one specific example embodiment of the waterfall processing unit 18. The 3D waterfall processing unit 108 obtains the cut-off frequency parameters and applies low pass filter on each of the channels of the corresponding structure section. The signal smoothing method maybe applied in a time axis and maybe in a distance axis to remove if any signal noise. The signal smoothing method like moving average may be used. The smoothed signals are converted to absolute values and accumulated over time axis to obtain waterfall intensity amplitudes. The 3D waterfall amplitude maybe normalized to enhance each of the section vibrations.

The trajectory detection unit 110 is one specific example embodiment of the trajectory detection unit 20. The trajectory detection unit 110 detects the trajectory that is the higher amplitudes of the passing vehicle observed as in the 3D waterfall dataset. The trajectory detection method may use Artificial Intelligence model (e.g., deep neural network model) to detect the trajectory patterns for each of the structural sections. The estimated trajectories for each of the sections are useful to monitor traffic and structure health conditions that is made possible by using structural passband filters (parameters).

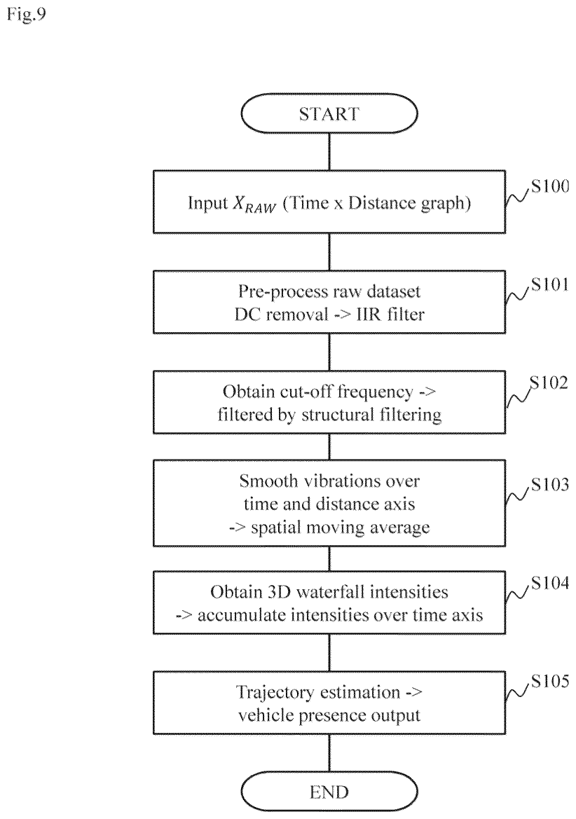

FIG. 9 is a flow chart illustrating an operation example of the monitoring apparatus 100 which extracts the 3D intensity amplitudes from the raw vibrations measured from the optical fiber cable.

The monitoring apparatus 100 receives from the signal acquisition unit 102, the oscillation signal (acoustics or vibration signal from the DAS).

The raw dataset processing unit 104 processes the XRAW (the raw dataset) as shown in FIG. 4A (S100). XRAW may be time-distance graph.

The pre-processing step (S101) removes amplitude offset that is DC (direct current) component (bias component) from measured signals possibly due to phase drift in DAS Interrogator and standardize signal amplitude. The pre-processing step may include IIR (Infinite impulse response) filtering.

The structural passband processing unit 106 obtains the structural passband parameters (S102) for each of the sections on the road as shown in FIG. 6. The raw dataset is used as input for obtaining the structural passband parameters. The cut-off frequency is obtained from pre-specified structural sections.

The step 103 applies the signal smoothing method to the time axis and distance axis, for example moving average method may be used.

The step 104 accumulates the vibration signal amplitudes (intensities) from the absolute values of the smooth signals over time axis. The accumulated intensity amplitudes may be normalized to enhance the trajectory information.

Thus, the 3D waterfall dataset is obtained.

The step 105 detects trajectory for each of the sensing points of the optical fiber cable. Estimated trajectory may indicate the presence of vehicle over the road. Trajectories are estimated and vehicle presence is output.

As the sensing apparatus 100 removes noise based on the structural properties, it can decrease noise from the time-distance oscillation data.

The program includes instructions (or software codes) that, when loaded into a computer, cause the computer to perform one or more of the functions described in the embodiments. The program may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray disc ((R): Registered trademark) or other optical disk storage, magnetic cassettes, magnetic tape, magnetic disk storage or other magnetic storage devices. The program may be transmitted on a transitory computer readable medium or a communication medium. By way of example, and not limitation, transitory computer readable media or communication media can include electrical, optical, acoustical, or other form of propagated signals.

Various combinations and selections of various disclosed elements (including each element in each example, each element in each drawing, and the like) are possible within the scope of the claims of the present disclosure. That is, the present disclosure naturally includes various variations and modifications that could be made by those skilled in the art according to the overall disclosure including the claims and the technical concept.

### REFERENCE SIGNS LIST

10 monitoring system
12 signal acquisition unit
14 raw dataset processing unit
16 passband processing unit
18 waterfall processing unit
20 trajectory detection unit
100 monitoring apparatus
102 signal acquisition unit
104 raw dataset processing unit
106 passband processing unit
108 waterfall processing unit
110 trajectory detection unit
21 vehicle
22 bridge section

What is claimed is:

1. A monitoring system comprising:
at least one memory storing instructions and
at least one processor configured to execute the instructions to:
acquire oscillation data at each of a plurality of sensing points in an optical fiber cable, the optical fiber cable being installed along a transportation infrastructure including a plurality of sections with structures different from each other;
obtain time-distance oscillation data of the transportation infrastructure based on the oscillation data;
obtain a filtering parameter for the time-distance oscillation data of each section of the transportation infrastructure based on a structural property of the section;
obtain waterfall data by removing noise from the time-distance oscillation data of each section of the transportation infrastructure using the filtering parameter; and
identify a trajectory of a moving object passing on the transportation infrastructure from the waterfall data.

2. The monitoring system according to claim 1, wherein
the at least one processor is further configured to execute the instructions to remove a bias component from the oscillation data before obtaining the time-distance oscillation data.

3. The monitoring system according to claim 1, wherein
the at least one processor is further configured to execute the instructions to obtain a cut-off frequency as the filtering parameter based on the structural property.

4. The monitoring system according to claim 1, wherein
the at least one processor is further configured to execute the instructions to smooth the time-distance oscillation data in a time axis and a distance axis.

5. The monitoring system according to claim 1, wherein
the at least one processor is further configured to execute the instructions to detect the trajectory by using a deep neural network model.

6. The monitoring system according to claim 1, wherein
the structural property includes at least one of a natural frequency of the section or the length of the section.

7. A monitoring method comprising:
acquiring oscillation data at each of the plurality of sensing points in an optical fiber cable, the optical fiber cable being installed along a transportation infrastructure including a plurality of sections with structures different from each other;
obtaining time-distance oscillation data of the transportation infrastructure based on the oscillation data;
obtaining a filtering parameter for the time-distance oscillation data of each section of the transportation infrastructure based on a structural property of the section;
obtaining waterfall data by removing noise from the time-distance oscillation data of each section of the transportation infrastructure using the filtering parameter; and
identifying a trajectory of a moving object passing on the transportation infrastructure from the waterfall data.

8. A non-transitory computer readable medium storing a program for causing a computer to execute:
acquiring oscillation data at each of the plurality of sensing points in an optical fiber cable, the optical fiber cable being installed along a transportation infrastructure including a plurality of sections with structures different from each other;
obtaining time-distance oscillation data of the transportation infrastructure based on the oscillation data;
obtaining a filtering parameter for the time-distance oscillation data of each section of the transportation infrastructure based on a structural property of the section;
obtaining waterfall data by removing noise from the time-distance oscillation data of each section of the transportation infrastructure using the filtering parameter; and
identifying a trajectory of a moving object passing on the transportation infrastructure from the waterfall data.
